(19) United States
(12) Patent Application Publication
(10) Pub. No.: US 2014/0238052 A1
(43) Pub. Date: Aug. 28, 2014

(54) INNER TANK SUPPORTING STRUCTURE FOR LNG STORAGE TANK FOR SHIP

(71) Applicants: DAEWOONG CRYOGENIC TECHNOLOGY CO., LTD., Gimhae-si, Gyeongsangnam-do (KR); HYUNDAI HEAVY INDUSTRIES CO., LTD., Ulsan (KR)

(72) Inventors: Sang Beom Shin, Ulsan (KR); Dong Ju Lee, Ulsan (KR); Dae Soon Kim, Ulsan (KR); Wha Soo Kim, Ulsan (KR); Dae Young Kim, Ulsan (KR); Do Hyun Kim, Ulsan (KR); Myung Sub Lee, Ulsan (KR); Hyung Kook Jin, Ulsan (KR)

(73) Assignees: HYUNDAI HEAVY INDUSTRIES CO., LTD., Ulsan (KR); DAEWOONG CRYOGENIC TECHNOLOGY CO., LTD., Gimhae-si, Gyeongsangnam-do (KR)

(21) Appl. No.: 14/349,729

(22) PCT Filed: Oct. 12, 2012
(86) PCT No.: PCT/KR2012/008283

§ 371 Date: Apr. 4, 2014

(30) Foreign Application Priority Data
Oct. 18, 2011 (KR) 10-2011-0106238

(51) Int. Cl. F17C 3/02; B63B 25/16; F17C 13/08

(52) U.S. Cl. CPC F17C 3/025; F17C 13/082; B63B 25/16
USPC 62/53.2

(57) ABSTRACT

The present invention relates to an inner tank supporting structure for an LNG storage tank for a ship, which does not restrict expansion or contraction of an inner tank in circumferential and lengthwise directions while the inner tank is expanded or contracted due to a temperature change caused by storage and discharge of LNG. The inner tank supporting structure for the LNG storage tank which has a cylindrical outer tank and a cylindrical inner tank, includes: a sliding main supporter mounted at one side of a bottom of the outer tank so as to fix the center of a bottom surface of the inner tank, the sliding main supporter having elongated sliding grooves formed in the lengthwise direction of the inner tank; a sliding main supporter mounted at the other side of the bottom of the outer tank so as to fix the center of the bottom surface of the inner tank, the sliding main supporter having round grooves; and a sub supporter mounted at the bottom of the outer tank so as to support the bottom surface of the inner tank, wherein the bottom surface of the inner tank is not fixed to the sub supporter.

### TECHNICAL FIELD

The present invention relates to an inner tank supporting structure for an LNG storage tank for a ship, and more particularly, to an inner tank supporting structure for an LNG storage tank for a ship, which can be smoothly expanded or contracted in a lengthwise direction and in a circumferential direction.

### BACKGROUND ART

In general, liquefied natural gas (LNG) means liquid of an extremely low temperature which is made by compressing, cooling and liquefying hydrocarbon-based natural gas, which is drawn out from the ground, at 162 degrees below zero so as to reduce volume of the natural gas to 1/600 for the sake of convenience in transport and storage.

The demand of the liquefied natural gas is increasing as clean energy because the liquefied natural gas has quantity of heat beyond of price and is in the limelight as substitute energy for petroleum.

Design and construction of a tank for transferring LNG cargo and storing fuel oil are mainly defined by International Maritime Organization (IMO) through application of International Gas carrier Code (IGC Code).

The IGC Code allows cargo containment systems of a wide range.

A cylindrical tank system is one of the widest containment systems to store liquefied natural gas cargo and fuel oil with the volume of about 22,000 or below.

Hereinafter, referring to FIGS. 1 and 2, a cylindrical LNG storage tank will be described in brief.

The cylindrical LNG storage tank includes an outer tank 1 forming the exterior of the storage tank and an inner tank for storing LNG.

The inner tank 2 is arranged inside the outer tank 1, and is fixed to the bottom of the outer tank 1 by a sliding supporter 3 and a fixing supporter 4.

The sliding supporter 3 and the fixing supporter 4 are mounted at the lower middle part of a space formed between the outer tank 1 and the inner tank 2 and support the bottom surface of the inner tank 2.

In this instance, the supporters 3 and 4 are arranged at both sides of the bottom surface of the inner tank 2 to support the inner tank 2 in equilibrium.

The inner tank 2 is fixed on the supporters 3 and 4 by fixing means, such as bolts 5.

In this instance, the sliding supporter 3 has sliding grooves 3a formed in a lengthwise direction of the inner tank 2, and the fixing supporter 4 has round grooves 4a.

The bolts 5 are arranged in the grooves 3a and 4a of the supporters 3 and 4.

Such a structure is to control stress due to contraction of the inner tank 2 when LNG of extremely low temperature is stored in the inner tank 2 and the inner tank 2 is contracted by a temperature change.

In other words, the structure is to compensate a movement distance of the inner tank 2 due to contraction or expansion of the inner tank 2 so as to prevent excessive concentration of stress on the supporters 3 and 4 while the inner tank 2 is contracted in the lengthwise direction or is expanded after LNG is wholly discharged out.

As described above, because the sliding supporter 3 has the sliding grooves 3a formed in the lengthwise direction and the bolts 5 are arranged in the sliding grooves 3a to fix the inner tank 2, the inner tank 2 can be moved along the sliding grooves 3a even though the inner tank 2 is contracted or expanded.

However, such a structure of the conventional LNG storage tank has the following problems.

When the LNG of extremely low temperature is stored in the inner tank 2 or is discharged from the inner tank 2, the inner tank 2 is contracted or expanded by a temperature change.

During the above process, stress is concentrated on the supporter 3 to which the inner tank 2 is fixed such that the fixed portion of the supporter 3 may be damaged.

In order to solve the above-mentioned problems, the sliding supporter 3 has the sliding grooves 3a formed in the lengthwise direction in order to secure the movement distance of the inner tank 2 according to the lengthwise contraction or expansion of the inner tank 2, but because the inner tank 2 can be moved only in the lengthwise direction, the conventional LNG storage tank cannot control stress when contraction is generated in a circumferential direction.

That is, because both sides of the inner tank 2 are fixed to the outer tank 1, the inner tank 2 cannot be contracted or expanded in the circumferential direction, and hence, there is a limitation in dispersing stress concentrated on the sliding supporter 3 and the fixing supporter 4.

### DISCLOSURE

### Technical Problem

Accordingly, the present invention has been made to solve the above-mentioned problems occurring in the prior arts, and it is an object of the present invention to provide an inner tank supporting structure for an LNG storage tank for a ship, which is expandable and contractable not only in a lengthwise direction but also in a circumferential direction because only the central portion of the bottom surface of an inner tank is fixed to an outer tank and the inner tank can be moved in the lengthwise direction.

### Technical Solution

To achieve the above objects, the present invention provides an inner tank supporting structure for an LNG storage tank for a ship which includes a cylindrical outer tank and a cylindrical inner tank, including: a sliding main supporter mounted at one side of a bottom of the outer tank so as to fix the center of a bottom surface of the inner tank, the sliding main supporter having elongated sliding grooves formed in the lengthwise direction of the inner tank; a sliding main supporter mounted at the other side of the bottom of the outer tank so as to fix the center of the bottom surface of the inner tank, the sliding main supporter having round grooves; and a sub supporter mounted at the bottom of the outer tank so as to support the bottom surface of the inner tank, wherein the bottom surface of the inner tank is not fixed to the sub supporter.

In this instance, the sub supporter includes: sliding members respectively mounted at both sides of the bottom of the inner tank along the curvature of the inner tank; a pair of supports mounted on the outer tank in such a way as to be opposed to the sliding members, the supports being respectively mounted at portions corresponding to both end portions of the sliding members; and buffering members respectively interposed between the supports and the sliding members.

Moreover, fixing members are arranged on the bottom surface of the inner tank for joining the inner tank to the sliding grooves of the sliding main supporter and the round grooves of the fixing main supporter, and are mounted in such a way as to be moved inside the sliding grooves of the sliding main supporter.

### Advantageous Effects

The inner tank supporting structure for the LNG storage tank for the ship according to the preferred embodiment of the present invention has the following effects.

Because the inner tank is expandable and contractable not only in the lengthwise direction but also in the circumferential direction without regard to directions, stress on the fixed portion of the inner tank is dispersed, such that the fixed portion and the inner tank are not damaged.

### DESCRIPTION OF DRAWINGS

FIG. 1 is a side sectional view of a conventional inner tank supporting structure for an LNG storage tank;

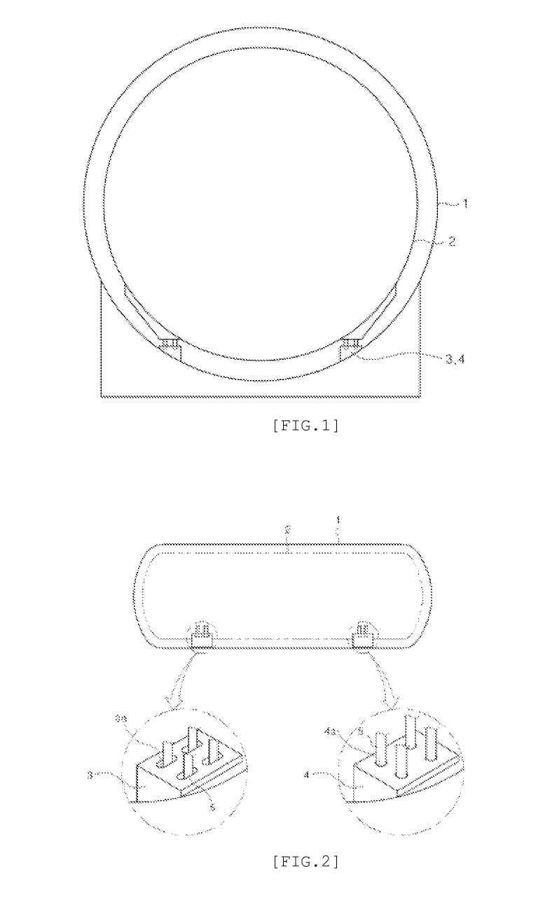

FIG. 2 is a front view of the conventional inner tank supporting structure for the LNG storage tank;

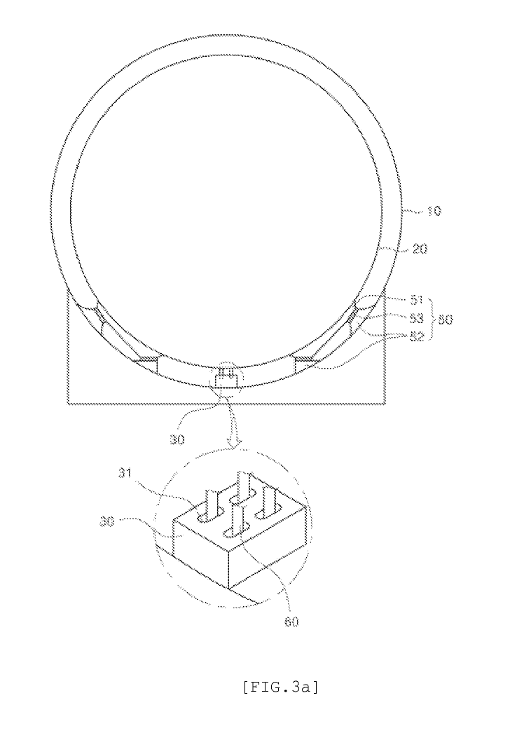

FIGS. 3a and 3b are a left-side sectional view and a right-side sectional view showing an inner tank supporting structure for an LNG storage tank for a ship according to a preferred embodiment of the present invention; and

FIGS. 4a and 4b are a side sectional view and a bottom view showing a state of the inner tank which is contracted by the inner tank supporting structure for the LNG storage tank for the ship according to the preferred embodiment of the present invention.

### MODE FOR INVENTION

It will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention.

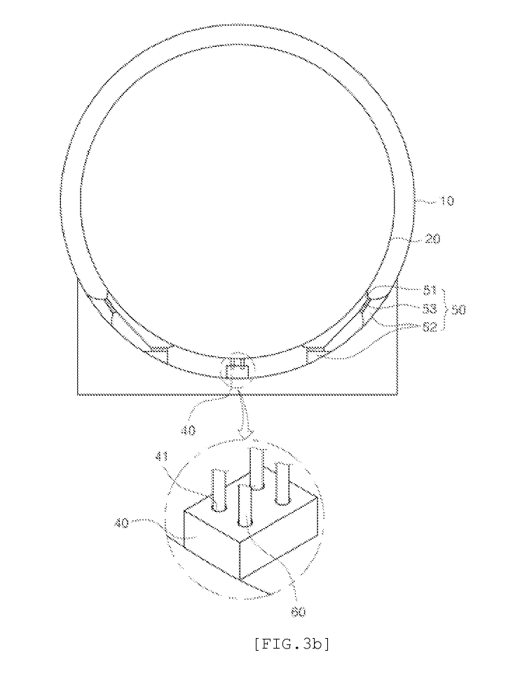

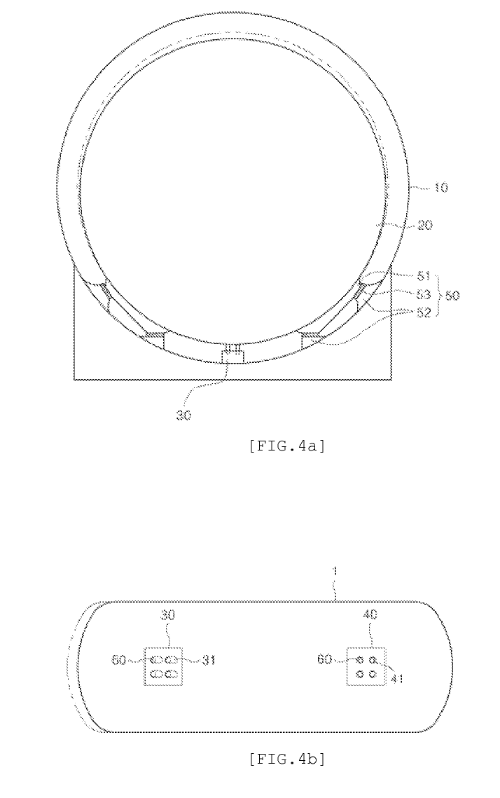

Hereinafter, referring to FIGS. 3a to 4b, an inner tank supporting structure for an LNG (Liquefied Natural Gas) storage tank for a ship according to a preferred embodiment of the present invention will be described.

The LNG storage tank includes: an outer tank 10 which forms the external appearance of the storage tank and is supported by a saddle inside a hold of the ship; an inner tank 20 arranged inside the outer tank 10; a sliding main supporter 30 for supporting the inner tank 20 inside the outer tank 10; a fixing main supporter 40; a sub-supporter 50; and a fixing member 60.

The inner tank 20 stores LNG of extremely low temperature (about 162 degree below zero), and has a predetermined space for storing the LNG.

The inner tank 20 is constructed of a plurality of metal plates which are connected integrally by welding.

Therefore, the storage tank can store and transfer LNG in safety without any leak of the LNG.

Moreover, the inner tank 20 may have corrugation for coping with a temperature change due to transshipment of the LNG.

Next, the sliding main supporter 30 and the fixing main supporter 40 serve to fix the inner tank 20 to the outer tank 10 and are arranged at a lower middle part of a space formed between the inner tank 20 and the outer tank 10.

As shown in FIG. 3a, the sliding main supporter 30 is mounted at a side of a lower part of the outer tank 10 and corresponds to the center of the bottom surface of the inner tank 20.

That is, the sliding main supporter 30 fixes the center of the bottom surface of the inner tank 20 at one side of the outer tank 10.

Furthermore, the sliding main supporter 30 has sliding grooves 31 in each of which a fixing member which will be described later is inserted.

The sliding grooves 31 are elongated grooves formed in the lengthwise direction of the inner tank 20.

In other words, the inner tank 20 is fixed to the sliding main supporter 30 by the fixing members 50 and is movable to the left and the right of the storage tank as long as the sliding grooves 31.

As shown in FIG. 3b, the fixing main supporter 40 is mounted at the other side of the lower portion of the outer tank 10 and corresponds to the center of the bottom surface of the inner tank 20.

In this instance, the fixing main supporter 40 has round grooves 41 in each of which a fixing member which will be described later is inserted.

The round grooves 41 are portions in which the fixing members are inserted, but the fixing members are not moved inside the round grooves 41 like in the sliding grooves 31.

That is, when the inner tank 20 is contracted in the lengthwise direction, the sliding main supporter 30 is moved based on the fixing main supporter 40.

Next, sub supporters 50 support both sides of the lower portion of the inner tank 10 and are respectively mounted at both sides of the sliding main supporter 30 and the fixing main supporter 40 when the storage tank is viewed from the side.

In other words, the sub supporters 50 are respectively mounted at both sides of the inside of the outer tank 10 based on the main supporters 30 and 40, and as shown in FIGS. 3a and 3b, support both sides of the bottom surface of the inner tank 20.

In this instance, the sub supporters 50 and the inner tank 20 are in an unfixed state.

The reason is not to restrict circumferential expansion or contraction of the inner tank 20.

If the inner tank 20 is provided in a state where both sides of the bottom surface of the inner tank 20 are fixed to the sub supporters 50, it would be understood that the inner tank 20 would not be expanded or contracted in the circumferential direction like the inner tank of the conventional storage tank.

Therefore, the inner tank 20 is in the state where both sides of the bottom surface are seated on the sub supporters 50.

In the meantime, each of the sub supporters 50 includes a sliding member 51, a support 52 and a buffering member 53.

The sliding members 51 serve to guide the inner tank 20 when the inner tank 20 is contracted in the circumferential direction, and are respectively mounted at both sides of the bottom surface of the inner tank 20.

It is preferable that the sliding member 51 be formed along the curvature of the bottom surface of the inner tank 20 and be made of aluminum-based or austenite-based stainless steel material which is not deteriorated in mechanical property at low temperature.

Additionally, the support 52 is to support the inner tank 20, and serves to support the sliding member 51 mounted in the inner tank 20.

The supports 52 are respectively mounted at both sides of the outer tank 10 based on the sliding main supporter 30.

Moreover, it is preferable that a pair of the supports 52 be provided to respectively support one end portion and the other end portion of the sliding member 51 and be made of aluminum-based or austenite-based stainless steel material which is not deteriorated in mechanical property at low temperature.

In this instance, exposed surfaces of the supports 52 respectively correspond to the curvature of the sliding members 51.

Furthermore, the buffering member 53 serves to relieve shock between the sliding member 51 and the support 52 and to prevent a noise generated by mechanical friction while the sliding member 51 slides along the support 52.

In this instance, the buffering members 53 are respectively mounted on the exposed surfaces of the supports 42 and come into contact with one end portion and the other end portion of the sliding members 51.

The buffering member 53 is not restricted in its material, but it is preferable that the buffering member 53 be made of FRP (Fiber Reinforced Plastics).

The FRP means resin that a fiber material is mixed with synthetic resin in order to enhance mechanical strength, and has a long lifespan, is lightweight and strong, and is not corroded.

Additionally, the FRP is chemically divided into G-FRP in which glass fiber is mixed and C-FRP in which carbon fiber is mixed, and is divided into silicon-based FRP and phenolic-based FRP according to resin bases.

Next, the fixing members 60 serve to fix the inner tank 20 to the sliding main supporter 30 and the fixing main supporter 40, and are preferably bolts.

One end portion of the fixing member 60 is fixed at the bottom surface of the inner tank 20 and the other end portion is arranged in the groove 31 of the sliding main supporter 30 and the groove 41 of the fixing main supporter 40.

In this instance, the fixing members 60 may be fixed at the grooves 31 and 41 of the main supporters 30 and 40 by fastening means, such as nuts, or may be riveted on the sliding grooves 31.

The structure and the method for fixing the fixing members 60 on the sliding grooves 31 are not limited.

Hereinafter, assembly and action of the inner tank supporting structure for the LNG storage tank for the ship according to the preferred embodiment of the present invention having the above-mentioned structure will be described with reference to FIGS. 4a and 4b.

After the inner tank 20 is inserted into the outer tank 10, the inner tank 20 is seated on the main supporters 30 and 40 and the sub supporter 50 mounted at the lower part of the outer tank 10.

In this instance, the lower middle part (See FIG. 4a) of the inner tank 20 is seated on the main supporters 30 and 40, and both sides of the bottom surface of the inner tank 20 is seated on the sub supporter 50.

In this instance, both end portions of the sliding member 51 of the sub supporter 50 come into contact with the buffering members 53 respectively mounted on the supports 52.

After that, the fixing members 50 inserted into the sliding grooves 31 of the main supporter 30 and into the round grooves 41 of the main supporter 40 are fixed to the main supporters 30 and 40.

After that, the space formed between the inner tank 20 and the outer tank 10 is in a vacuum state, such that installation of the LNG storage tank is finished.

After that, LNG is stored in the inner tank 20 of the installed storage tank.

In this instance, because the LNG of extremely low temperature is stored in the inner tank 20, the inner tank 20 is contracted due to a descent of temperature.

As shown in FIGS. 4a and 4b, the inner tank 20 is contracted in the circumferential direction and in the lengthwise direction.

In this instance, in connection with contraction of the inner tank 20 in the circumferential direction, because the lower middle part (see FIG. 4a) of the inner tank 20 is fixed to the sliding main supporter 30 and the fixing main supporter 40, both sides of the inner tank 20 are contracted based on the fixed lower middle part.

In this instance, both sides of the bottom surface of the inner tank 20 are contracted while the sliding members 51 are guided along the supports 52.

Even though the sliding members 51 are made of metal, because they are guided by the buffering members 53 made of synthetic resin, noise and abrasion due to mechanical friction can be minimized.

Moreover, in connection with the lengthwise contraction of the inner tank 20, because the bottom surface of the inner tank 20 is fixed to the fixing main supporter 40 mounted at the left side (see FIG. 4a) of the outer tank 10, the fixing members 60 fixed at the right side of the bottom surface of the inner tank can be moved along the sliding grooves 31 formed in the sliding main supporter 30.

Therefore, stress is not concentrated on the sliding main supporter 30 and the fixing main supporter 40.

As described above, the inner tank supporting structure for the LNG storage tank for the ship according to the preferred embodiment of the present invention can prevent concentration of stress on the fixed portions because the inner tank can be smoothly expanded or contracted according to the temperature change while the LNG of extremely low temperature is stored or discharged out.

That is, because only the lower middle part of the inner tank is fixed to the lower portion of the outer tank, both sides of the inner tank can be expanded or contracted in the circumferential direction.

Therefore, the inner tank can be expanded or contracted in the circumferential direction as well as in the lengthwise direction, and hence, stress is not concentrated on the fixed portions of the inner tank and the outer tank.

While the present invention has been particularly shown and described with reference to exemplary embodiments thereof, it will be understood by those of ordinary skill in the art that various changes and modifications may be made therein without departing from the technical idea and scope of the present invention and such changes and modifications belong to the claims of the present invention.

1. An inner tank supporting structure for an LNG storage tank for a ship which includes a cylindrical outer tank and a cylindrical inner tank, comprising:
a sliding main supporter mounted at one side of a bottom of the outer tank so as to fix the center of a bottom surface of the inner tank, the sliding main supporter having elongated sliding grooves formed in the lengthwise direction of the inner tank;
a sliding main supporter mounted at the other side of the bottom of the outer tank so as to fix the center of the bottom surface of the inner tank, the sliding main supporter having round grooves; and
a sub supporter mounted at the bottom of the outer tank so as to support the bottom surface of the inner tank,
wherein the bottom surface of the inner tank is not fixed to the sub supporter.

2. The inner tank supporting structure according to claim 1, wherein the sub supporter comprises:
sliding members respectively mounted at both sides of the bottom of the inner tank along the curvature of the inner tank;
a pair of supports mounted on the outer tank in such a way as to be opposed to the sliding members, the supports being respectively mounted at portions corresponding to both end portions of the sliding members; and
buffering members respectively interposed between the supports and the sliding members.

3. The inner tank supporting structure according to claim 1, wherein fixing members are arranged on the bottom surface of the inner tank for joining the inner tank to the sliding grooves of the sliding main supporter and the round grooves of the fixing main supporter, and are mounted in such a way as to be moved inside the sliding grooves of the sliding main supporter.
